(19) United States
(12) Patent Application Publication
(10) Pub. No.: US 2005/0007719 A1
(43) Pub. Date: Jan. 13, 2005

(54) Overvoltage arrester

(75) Inventors: Gerd Philipp, Boeblingen (DE); Wolfgang Beerwerth, Steinenbronn (DE)

Correspondence Address: LAW OFFICE OF BARRY R LIPSITZ, 755 MAIN STREET, MONROE, CT, 06468, US

(73) Assignee: Telegaertner Karl Gaertner GmbH, Steinenbronn (DE)

(21) Appl. No.: 10/873,425

(22) Filed: Jun. 21, 2004

Related U.S. Application Data
(63) Continuation of application No. PCT/EP02/14540, filed on Dec. 19, 2002.

(30) Foreign Application Priority Data
Dec. 22, 2001 (DE) 101 63 862.0

(51) Int. Cl. H02H 9/06

(52) U.S. Cl. 361/119

(57) ABSTRACT

The invention relates to an overvoltage arrester for high-frequency lines comprising a coaxial line section with an inner conductor and an outer conductor, and a short-circuit conductor which branches off from the inner conductor and is electrically connected to the outer conductor. In order to design the overvoltage arrester such that it enables transmission of a supply voltage in a constructionally simple way and ensures reliable protection against electromagnetic interference pulses, it is proposed, in accordance with the invention, that the short-circuit conductor be connected to the outer conductor solely via an arrester configured as a varistor, with the varistor forming the only discrete electrically active element between the short-circuit conductor and the outer conductor.

The present disclosure relates to the subject matter disclosed in international application PCT/EP02/14540 of Dec. 19, 2002, which is incorporated herein by reference in its entirety and for all purposes.

### BACKGROUND OF THE INVENTION

The invention relates to an overvoltage arrester for high-frequency lines comprising a coaxial line section with an inner conductor and an outer conductor, and a short-circuit conductor which branches off from the inner conductor and is electrically connected to the outer conductor.

Such overvoltage arresters are used, for example, in communications technology and serve to protect electric apparatus against electromagnetic interference pulses. Interference pulses can be generated by, for example, motors, switches, switched-mode power supply units or the like. They are also caused by strokes of lightning and are coupled, for example, inductively or capacitively with coaxial lines and passed via these to the connected apparatus. This may result in damage to or even destruction of the apparatus.

As protection against such electromagnetic interference pulses, European published patent application EP 0 855 756 A1 proposes use of a λ/4 conductor which is connected via an arrester, for example, a gas discharge cell, to the outer conductor of the coaxial line section. It forms a high-frequency filter and allows transmission of electric signals of a certain frequency band, while interference pulses with frequencies outside the allowed frequency band are reflected or eliminated. Here a “λ/4 conductor” is understood as a short-circuit conductor whose electrically effective length is matched to the wavelength of the frequency band to be transmitted by the electrically effective length being equal to a quarter or a multiple of a quarter of the wavelength of the signal to be transmitted with the useful band center frequency. Such a λ/4 conductor connected via an arrester to the outer conductor of the coaxial line section acts as a frequency-selective filter for high-frequency electric signals present at the inner conductor of the coaxial line section. By arrangement of impedances at the coaxial line section, an additional band width or even an extension to several transmission ranges can be achieved. It is then not necessary for the short-circuit conductor to be matched in its length to a quarter of the wavelength or a multiple of this quarter wavelength of the frequency range to be transmitted. Rather, depending on the length of the short-circuit conductor, which is also referred to as impedance conductor, a more or less broad frequency band is transmitted, whereas high-frequency signals lying outside the frequency band are not transmitted.

Overvoltage arresters are used, for example, in the transmission of a signal from an antenna to a signal receiver. It is desirable to feed a supply voltage to a pre-amplifier arranged in an exposed manner on the antenna via the inner conductor of the coaxial line section. This may be a direct voltage or a low-frequency alternating voltage. To enable reliable transmission of such supply voltages and, in addition, ensure reliable protection against electromagnetic interference pulses, it is proposed in European published patent application EP 0 938 166 A1 that there be connected in parallel with the arrester a concentrated capacitor which connects the λ/4 conductor at the base for high-frequency voltages with the outer conductor of the coaxial line section. A varistor connected in parallel with the concentrated capacitor may, for example, be used here as arrester.

The combined use of an arrester and a concentrated capacitor connected in parallel therewith together with the λ/4 conductor enables transmission of a supply voltage and forms an overvoltage protector, but it involves quite considerable constructional expenditure and corresponding manufacturing costs.

The object of the present invention is to further develop an overvoltage arrester of the kind mentioned at the outset such that it enables transmission of a supply voltage in a constructionally simpler way and ensures reliable protection against electromagnetic interference pulses.

### SUMMARY OF THE INVENTION

This object is accomplished with an overvoltage arrester of the generic kind, in accordance with the invention, in that the short-circuit conductor is connected to the outer conductor solely via an arrester configured as a varistor, with the varistor forming the only discrete electrically active element between the short-circuit conductor and the outer conductor.

It has been found that the use of a varistor alone as discrete, electrically active element for connecting the short-circuit conductor to the outer conductor of the coaxial line section both ensures reliable protection against electromagnetic interference pulses and enables transmission of a low-frequency supply voltage or a supply voltage configured as a d.c. voltage. In this connection, a voltage-dependent resistor which with increasing voltage exhibits an extremely strong decrease in the differential resistance value is referred to as varistor. Overvoltage peaks can be reliably diverted via the varistor to the outer conductor of the coaxial line section, normally to its housing. When an overvoltage pulse occurs, the varistor suddenly changes its resistance value and then forms, with a response time in the nanosecond range, an extremely low resistance value, for example, several ohms, whereas in the normal operating state it has a resistance value of several megohms. It has been found that the exclusive connection of a short-circuit conductor to the outer conductor of the coaxial line section via the varistor as sole discrete electrically active element already ensures reliable protection against electromagnetic interference pulses, and, at the same time, supply voltages, preferably d.c. voltages, can be transmitted via the inner conductor. The additional use of a discrete electrically active component connected in parallel or in series with the varistor, for example, a concentrated capacitor connected in parallel and/or a coil connected in series, can be dispensed with. The overvoltage arrester according to the invention is consequently characterized by a significant constructional simplification and can be manufactured more cost-effectively.

As explained hereinabove, the short-circuit conductor can be matched in its length to a quarter of the wavelength of the signal to be transmitted with the useful band center frequency or to a multiple of this quarter wavelength. In addition, by suitable arrangement of impedances in the coaxial line section, as mentioned hereinabove, the useful frequency range can be enlarged to wide frequency bands.

It is particularly advantageous for the varistor to be disk-shaped. This makes particularly simple assembly of the varistor at the free end of the short-circuit conductor possible. For example, provision may be made for the varistor to comprise a metal oxide disk with a vapor-deposited metal, for example, silver coating on its upper side and its underside. The metal oxide is preferably pressed, and the use of pressed zinc oxide has proven particularly advantageous.

Particularly cost-effective assembly of the overvoltage arrester is achievable by the varistor being detachably connectable via a plug connection to the short-circuit conductor. For example, provision may be made for the varistor to rest surface-to-surface on a contact plate which carries on its side facing away from the varistor a socket which is detachably connectable to the end of the short-circuit conductor facing away from the inner conductor of the coaxial line section. The contact plate is preferably made of metal, for example, brass.

In a particularly preferred embodiment of the overvoltage arrester according to the invention provision is made for the overvoltage arrester to comprise a sleeve which protrudes from the coaxial line section, surrounds the short-circuit conductor and carries at its free end a housing which accommodates the varistor.

The housing is preferably of two-part design, with the two housing parts being releasably connectable to each other. This makes particularly simple assembly of the overvoltage arrester possible, and in the event of damage, the varistor can be exchanged in a simple way.

The housing accommodating the varistor preferably comprises a first housing part which is connected to the sleeve and defines a tub-shaped receptacle, and a second housing part which covers the tub-shaped receptacle and is detachably connectable, preferably screwable, to the first housing part, with the varistor being insertable into the tub-shaped receptacle. It is expedient for the first housing part to be integrally connected to the sleeve.

To secure the varistor inside the housing, it is advantageous for a carrier plate which supports the varistor to be held in the housing. It is expedient for the carrier plate to be of electrically conductive design. It may, for example, be made of a metal.

Provision may be made for the carrier plate to be held between the two housing parts of the housing accommodating the varistor. The carrier plate is preferably clamped to the two housing parts.

It is particularly advantageous for the overvoltage arrester to comprise an externally contactable terminal which is connectable to the short-circuit conductor via an electric connecting element. This makes it possible, for example, for testing and measuring purposes, to tap at the terminal the electric voltage present at the short-circuit conductor. Furthermore, a voltage, preferably a supply voltage or control voltage, or a control signal can be applied to the short-circuit conductor via the terminal. As explained hereinabove, the overvoltage arrester according to the invention may be used, for example, in the transmission of a signal from an antenna to a signal receiver. A pre-amplifier may be arranged at the antenna, and the terminal electrically connected to the short-circuit conductor makes it possible to pass the supply voltage for the pre-amplifier via the short-circuit conductor and the inner conductor of the coaxial line section to the pre-amplifier or to tap a supply voltage present at the pre-amplifier.

It is expedient for the terminal to be detachably connectable to the short-circuit conductor. Both assembly and repair of the overvoltage arrester according to the invention can thereby be simplified.

In a particularly preferred embodiment of the overvoltage arrester according to the invention, the varistor has a through-opening, and the electric connecting element which establishes a connection between the terminal and the short-circuit conductor is guided through the through-opening of the varistor. This makes a particularly compact design of the overvoltage arrester possible, in which it may be of particularly narrow construction.

The following description of a preferred embodiment of the invention serves in conjunction with the drawings to explain the invention in greater detail.

### BRIEF DESCRIPTION OF THE DRAWINGS

FIG. 1 shows a partly broken open side view of an overvoltage arrester according to the invention; and

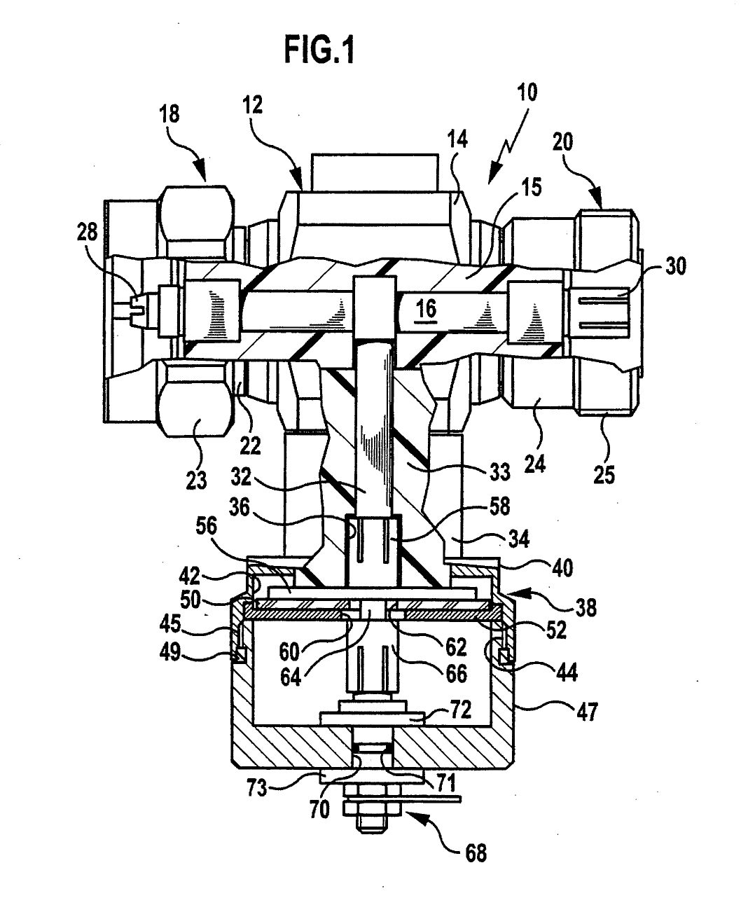

FIG. 2 shows an electric circuit diagram of the overvoltage arrester according to the FIG. 1.

### DETAILED DESCRIPTION OF THE INVENTION

An overvoltage arrester generally designated by the reference numeral 10 is shown in the drawings. The overvoltage arrester 10 comprises a coaxial line section 12 with a metallic outer conductor 14 of substantially hollow cylindrical design. Extending through the outer conductor 14 is an isolator 15 of hollow cylindrical design which, in turn, receives a coaxially oriented inner conductor 16. The coaxial line section 12 carries at its ends connecting means 18 and 20, respectively, via which the coaxial line section 12 can be connected to further coaxial conductors or to electrical devices. For example, provision may be made to connect the coaxial line section 12 in the interconnection between an antenna and an associated receiver.

In the illustrated embodiment, the connecting means 18 and 20 each comprise a flange 22 and 24, respectively, secured at the front face to the coaxial line section 12. A cap nut 23 with an internal thread, not shown in the drawings, is held on the flange 22, while the flange 24 carries an external thread 25. The cap nut 23 surrounds a connecting plug 28 which is electrically connected to the inner conductor 16, and in the area of the external thread 25 of the flange 24 the inner conductor 16 is electrically connected to a connecting socket 30.

The configuration of the connecting means 18 and 20 may, in compliance with the requirements of other plug connector systems (standards) also be-adapted to these. Such configurations are known to the person skilled in the art and are, therefore, not shown in further detail in the drawings.

At the center in the longitudinal direction there branches off from the inner conductor 16 a short-circuit conductor 32, which is surrounded by an isolator 33 and a metallic sleeve 34 which at its free end expands in a stepped manner and has a widening 36.

A metallic closure housing 38 is held at the free end of the sleeve 34. A first housing part 40 of the closure housing 38 delimits a tub-shaped receptacle 42 and is secured to the sleeve 34. Facing away from the sleeve 34, there is attached to the first housing part 40 an internal thread 44 which cooperates with a corresponding external thread 45 of a second housing part 47 of the closure housing 38 so that the second housing part 47 is screwable in the longitudinal direction of the short-circuit conductor 32 into the first housing part 40 and thereby covers the tub-shaped receptacle 42. To obtain a fluid-tight connection, a sealing ring 49 is held between the first and second housing parts 40 and 47, respectively. The sealing ring 49 rests against the inner side of the tub-shaped receptacle 42 and surrounds the second housing part 47 in circumferential direction.

The tub-shaped receptacle 42 accommodates a disk-shaped varistor 50, which is supported by a metallic carrier plate 52 which is clamped within the receptacle 42 between the first housing part 40 and the second housing part 47.

With its upper side facing away from the carrier plate 52, the varistor 50 rests surface-to-surface on a contact plate 56 made of brass. Facing away from the varistor 50, the contact plate 56 carries a socket 58 extending into the widening 36 of the sleeve 34.

The varistor 50 is in form of a pressed zinc oxide disk having silver vapor-deposited on its underside facing the carrier plate 52 and on its upper side facing the contact plate 56.

The varistor 50 and the carrier plate 52 have a central through-opening 60 and 62, respectively, through which a connection line 64 contacting the contact plate 56 is guided. At its end side facing away from the contact plate 56, the connection line 64 carries a socket 66 via which the connection line 64 is connected to an electric terminal 68, which passes through a through-bore 70 arranged at the center of the second housing part 47 and can be contacted externally. The terminal 68 is held in an electrically insulated manner by means of insulating sleeves 72 and 73 in the through-bore 70, and a sealing ring 71 inserted in the through-bore 70 prevents penetration of moisture.

An electric voltage, for example, a supply voltage or control voltage, may be connected via the terminal 68 and the connection line 64 to the short-circuit conductor 32. Furthermore, the terminal 68 makes it possible to tap the voltage present at the short-circuit conductor 32, for example, for measuring, testing and power supplying purposes.

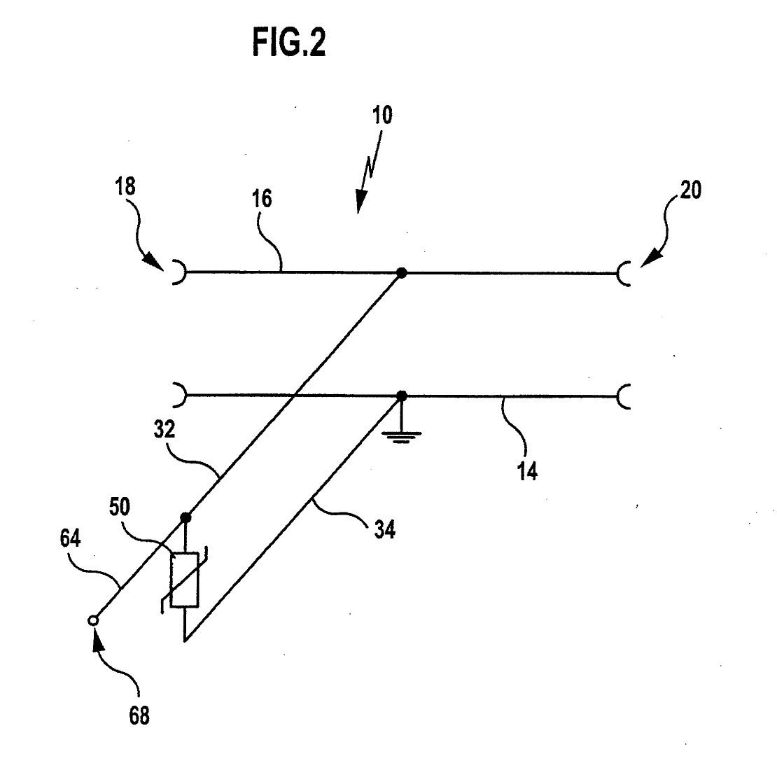

As will be apparent, in particular from the circuit diagram shown in FIG. 2, the short-circuit conductor 32 branching off from the inner conductor 16 is connected solely via the varistor 50 and otherwise only via the sleeve 34 connected in series with the varistor 50 and the contact plate and carrier plate 56 and 52, respectively, not shown in FIG. 2, likewise connected in series with the varistor 50, to the outer conductor 14 of the coaxial line section. The varistor is thus the only discrete electrically active element between the short-circuit conductor 32 and the outer conductor 14. It has been found that the combined use of the short-circuit conductor with the varistor 50 guarantees reliable protection of an apparatus connected, for example, to the connection socket 30 against electromagnetic interference pulses which are present in the area of the connecting plug 28 at the inner conductor 16. In addition, use of the varistor 50 enables transmission of a low-frequency supply voltage or a supply voltage configured as d.c. voltage via the inner conductor 16. The supply voltage may, for example, be fed to a pre-amplifier secured in an exposed position to an antenna which is connected via the connecting plug 28 to the inner conductor 16.

1. Overvoltage arrester for high-frequency lines comprising a coaxial line section with an inner conductor and an outer conductor, and a short-circuit conductor which branches off from the inner conductor and is electrically connected to the outer conductor, wherein the short-circuit conductor is connected to the outer conductor solely via an arrester configured as a varistor, with the varistor forming the only discrete electrically active element between the short-circuit conductor and the outer conductor.

2. Overvoltage arrester in accordance with claim 1, wherein the varistor is disk-shaped.

3. Overvoltage arrester in accordance with claim 1, wherein the varistor is detachably connectable via a plug connection to the short-circuit conductor.

4. Overvoltage arrester in accordance with claim 1, wherein the overvoltage arrester comprises a sleeve which protrudes from the coaxial line section, surrounds the short-circuit conductor and carries at its free end a housing which accommodates the varistor.

5. Overvoltage arrester in accordance with claim 4, wherein the housing is of two-part construction, and the two housing parts are detachably connectable to each other.

6. Overvoltage arrester in accordance with claim 4, wherein the housing comprises a first housing part which is connected to the sleeve and defines a tub-shaped receptacle, and a second housing part which covers the tub-shaped receptacle and is detachably connectable to the first housing part, with the varistor being insertable into the tub-shaped receptacle.

7. Overvoltage arrester in accordance with claim 4, wherein a carrier plate which supports the varistor is held in the housing.

8. Overvoltage arrester in accordance with claim 7, wherein the carrier plate is clamped between the two housing parts.

9. Overvoltage arrester in accordance with claim 1, wherein the overvoltage arrester comprises an externally contactable terminal which is connectable to the short-circuit conductor via an electric connecting element.

10. Overvoltage arrester in accordance with claim 9, wherein the terminal is detachably connectable to the short-circuit conductor.

11. Overvoltage arrester in accordance with claim 9, wherein the varistor has a through-opening through which the electric connecting element is guided.
